(19) United States
(12) Patent Application Publication
(10) Pub. No.: US 2009/0104816 A1
(43) Pub. Date: Apr. 23, 2009

(54) Conductor terminal

(76) Inventor: Hans-Josef Koellmann, Minden (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/250,026

(22) Filed: Oct. 13, 2008

(30) Foreign Application Priority Data
Oct. 22, 2007 (DE) 10 2007 050 683.1

(51) Int. Cl. H01R 13/40

(52) U.S. Cl. 439/625

(57) ABSTRACT

A conductor terminal (1) having an insulating-material housing (6), at least one spring-force clamping contact (4) which is accommodated in the insulating-material housing (6), and having at least one operating pusher (8) which is operatively connected to at least one respective spring-force clamping contact (4) and is displaceably guided in a guide channel (1) in the insulating-material housing (6) in order to open and to close the associated spring-force clamping contact (4) is described. The at least one guide channel (10) has a recess (11) for accommodating a section of the operating pusher (8) which is guided in the respective guide channel (10). The recess (11) and the section of the operating pusher (8) are matched to one another in such a way that the operating pusher (8) can be fixed in an unlocking position, in which the spring-force clamping contact (4) is open, in the recess (11).

The invention relates to a conductor terminal having an insulating-material housing, at least one spring-force clamping contact which is accommodated in the insulating-material housing, and having at least one operating pusher which is operatively connected to a respective spring-force clamping contact and is displaceably guided in a guide channel in the insulating-material housing in order to open and to close the associated spring-force clamping contact.

Conductor connections of this type are sufficiently well known, for example from DE 20 2005 014 510 U1. The operating pusher facilitates opening of the spring-force clamping contacts for inserting an electrical conductor.

DE 197 11 051 A1 describes an electrical terminal in which a pivot lever is incorporated in the insulating-material housing. Said pivot lever can be pivoted into the insulating-material housing with the aid of an operating tool, in order to move the clamping limb of a spring-force clamping connection and to open the spring-force clamping connection. The maximum pivoting movement of the pivot lever is limited by a stop in the insulating-material housing.

By way of example, DE 101 03 187 A1 discloses slide-operated electrical terminals. The slide-operated clamping limb of the clamping spring of the clamping point is positioned against a reference plane, which runs perpendicular to the linear track guides of the slide, with a V-shaped position, which is open at the top, and projects into the movement path of the slide. In the open position, a leading edge of the slide is extended under a retaining edge of the insulating-material housing, and so the return force of the clamping limb is also introduced into the retaining edge of the clamping housing and the operating slide is reliably fixed in position.

Taking this as the starting point, the object of the present invention is to provide an improved conductor terminal with an insulating-material housing into which various operating pushers, which can be fixed at least in an unlocking position, can be integrated.

The object is achieved by the conductor terminal of the type mentioned in the introduction in that the at least one guide channel has a recess for accommodating a section of the operating pusher which is guided in the respective guide channel, and in that the recess and the section of the operating pusher are matched to one another in such a way that the operating pusher can be fixed in an unlocking position, in which the spring-force clamping contact is open, in the recess.

The invention therefore proposes guiding the operating pusher in a guide channel and not in a track guide, with a recess providing a clearance in the guide channel so that a section of the operating pusher can be moved in order to fix the operating pusher in the unlocking position. The manufacturer is responsible for fitting the guide channel having the recess with a suitable operating pusher. In this case, it is firstly feasible for an operating pusher which can be pivoted into the recess to be provided, in order to be able to exploit the advantage of fixing the operating pusher in an unlocking position. However, this functionality is undesirable or impermissible under certain circumstances, and so an operating pusher which has a different shape and does not have a section which can be fixed in the recess can also be inserted into the guide duct.

In order to permit the operating pusher to be moved into the recess, it is advantageous when the guide channel and/or the operating pusher have/has conically tapering wall sections in such a way that the operating pusher is mounted in the guide channel such that it can pivot into the recess in the guide channel. The section of the operating pusher which can be fixed in the recess should in this case be wider than the narrow end of the conically tapering wall section.

However, it is also advantageous when the operating pusher has a flexible section between the section which can be fixed in the recess and the section which interacts with the spring-force clamping contact, which flexible section permits the operating pusher to be pivoted into the recess in the guide channel.

However, it is also advantageous when the operating pusher has several parts and has at least two operating elements which are mounted such that they can be displaced relative to one another, of which a main operating element is operatively connected to an associated spring-force clamping contact and a arresting operating element is provided with a section which interacts with the recess in the guide channel and in the main operating element, in order to fix the main operating pusher.

The additional arresting operating element has the advantage that arresting can be performed separately without transverse movement of the operating pusher and the position of the operating pusher, which is in the unlocked position, can be seen by way of the lug which may project far out of the insulating-material housing.

The unlocking position is understood to mean the unlocked position in which the spring-force clamping contact is open. Accordingly, the locking position is understood to be the position in which the spring-force clamping connection is closed.

In a multipartite operating pusher of this type, the arresting operating element preferably has a lug which extends in the longitudinal direction of the guide channel and projects from the insulating-material housing and has an arresting plate which branches obliquely from the lug. At least one indentation is provided in that wall of the main operating element which adjoins the lug, said indentation being matched to the recess in the guide channel and the arresting plate for fixing the main operating element in an unlocking position, in which the spring-force clamping contact is open, and/or in a locking position, in which the spring-force clamping contact is closed.

The spring-force clamping contact is closed by moving the lug which, in this case, delimits the main operating element which bounces up in the guide channel.

In order to fix the main operating element which can have the form of a cylindrical or cuboidal ram, it is advantageous when the at least one indentation in the main operating element enters the material of the main operating element obliquely in the direction of the spring-force clamping contact. In this way, the indentation of triangular cross section provides a bearing face for the arresting plate which is supported on the opposite side in the recess in the guide channel and, on account of the oblique profile of the arresting plate, prevents displacement of the main operating element in the guide channel in the upward direction away from the spring-force clamping connection.

The externally visible head area of the operating pusher can be used to receive an operating tool and/or to identify the ability to lock the operating pusher and/or to identify a predefined type of line connection. It is therefore advantageous when a cavity for accommodating an operating tool is provided in the externally accessible head section of the operating pusher, which cavity may be of slot-like or cross-like design. The shape of the cavity can then also be used as an identifier of a predefined type of line connection of the associated conductor connection. For example, a slot-like cavity may indicate a negative pole and a cross-like cavity may indicate a positive pole. However, it is also feasible for the phase or the like of the voltage potential which is provided for the conductor connection to be identified with the aid of the cavity.

It is also advantageous when a warning cover cap for closing the guide channel and preventing unintentional operation is connected in a pivotable and articulated manner to the outer wall of the insulating-material housing so as to adjoin the guide channel.

The invention is explained in greater detail below with reference to exemplary embodiments and the appended drawings, in which:

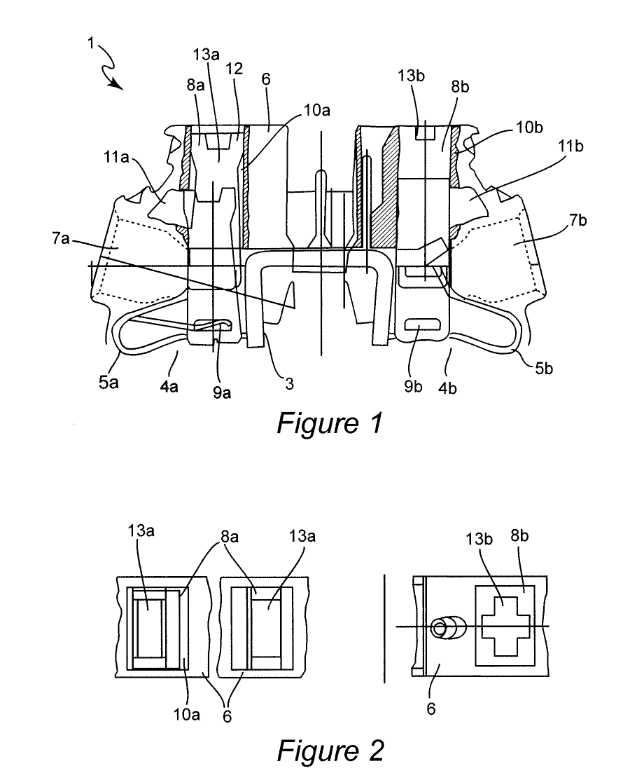

FIG. 1—shows a cross-sectional view of a conductor terminal with two spring-force clamping connections which are connected to one another by means of a busbar;

FIG. 2—shows a detail of a plan view of the conductor terminal from FIG. 1;

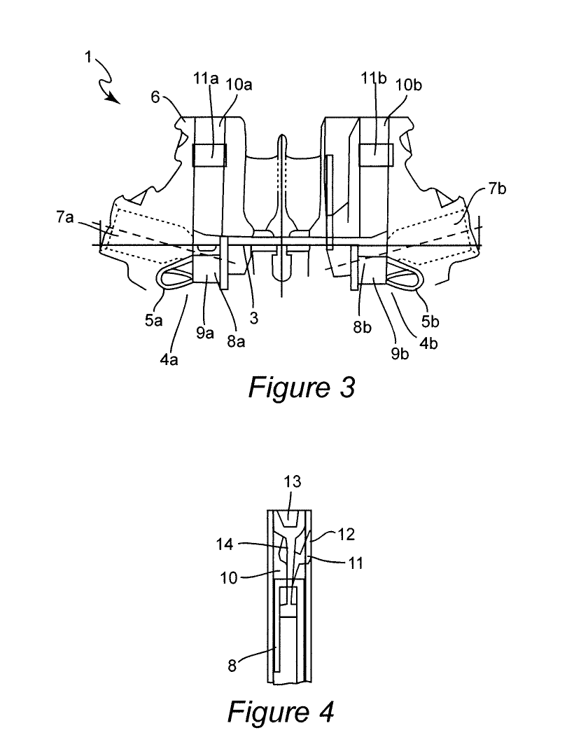

FIG. 3—shows a cross-sectional view of a second embodiment of a conductor terminal;

FIG. 4—shows a sectional view of the guide channel of the conductor terminal from FIG. 3 with flexible operating pushers;

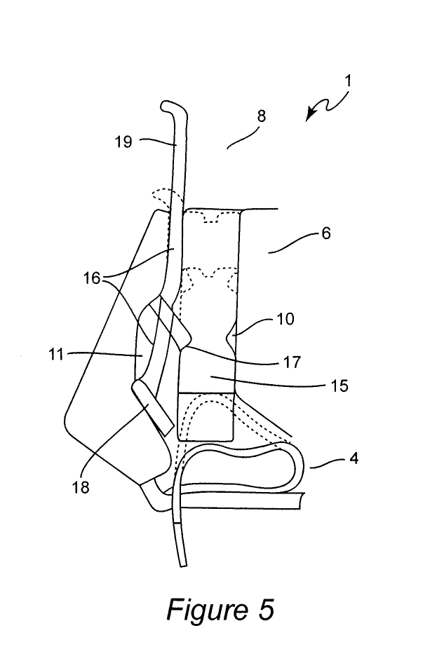

FIG. 5—shows a detailed sectional view of a third embodiment of a conductor terminal with a two-part operating pusher.

FIG. 1 shows a first embodiment of the conductor terminal 1 in cross section. The conductor terminal 1 has two spring-force clamping contacts 4a, 4b which are electrically conductively connected to one another by means of a busbar 3 and which are formed substantially from the busbar 3 and a clamping spring 5a, 5b. The spring-force clamping contacts 5a, 5b and the busbar 3 are accommodated in an insulating-material housing 6 in which the conductor insertion openings 7a, 7b which are oriented toward the spring-force clamping contacts 4a, 4b are made.

In order to open the clamping springs 5a, 5b, operating pushers 8a, 8b which are operatively connected to the clamping springs 5a, 5b are provided. To this end, at the guide slot 9a, 9b in which a guide section of the clamping spring 5a, 5b is hooked is in each case provided in the lower end region of the operating pushers 8a, 8b.

The operating pushers 8a, 8b are displaceably inserted into a respective guide channel 10a, 10b of the insulating-material housing 6. The guide channels 10a, 10b in each case contain a recess 1a, 11b into which the operating pusher 8a can be pivoted when the guide channel 10a and the shape of the operating pusher 8a are suitably configured, in order to fix the operating pusher 8a in an unlocking position in which the spring-force clamping contact is open. This has the advantage that a conductor can be easily inserted into and removed from the conductor guide opening 7a without continuously pressing down on the operating pusher 8a.

Although the guide channel 10a, 10b, by virtue of the respective recess 11a, 11b, permits an operating pusher 8a to be fixed in principle, another operating pusher 8b can optionally be used without reconfiguring the insulating-material housing 6, said other operating pusher preventing tilting into the recess 11b on account of its, for example, rectangular shape together with a constant cross section over the length, and it therefore not being possible to fix it.

In contrast to the rectangular operating pusher 8b, the left-hand, pivotable operating pusher 8a is configured in such a way that it has a cross section which tapers conically in the direction of the head section from that end which is operatively connected to the spring-force clamping contact 4a, and so the cross section reduces in the direction of the head end. In contrast, the head section 12 is again wider, and so the upper edge of the head section 12 for fixing the operating pusher 8a butts against an upper edge of the recess 11a when the operating pusher 8a is pivoted into the recess 11a.

The pivoting movement is made possible by the conically tapering wall adjoining the wall of the guide channel 10a in which the recess 11a is made.

However, it is also feasible for the wall of the guide channel 10a to be recessed beneath the recess 11a itself in order to permit the operating pusher 8a to be pivoted into the recess 11a. However, this has the disadvantage of poorer guidance of the operating pusher which cannot be fixed. In order to facilitate operation of the operating pusher 8a, 8b using an operating tool and possibly pivoting of the operating pusher 8a, a cavity 13a, 13b is made in the head section 12.

FIG. 2, which shows a plan view of the conductor terminal 1 from FIG. 1, shows that the cavity 13a of the operating pusher 8a on the left-hand side is in the form of a slot, whereas the cavity 13b of the operating pusher 8b on the right-hand side is in the form of a cross. The type of operating pusher can therefore be identified. For example, the slot-like cavity may indicate that the operating pusher 8b cannot be fixed. However, it is also feasible to identify the cavity 13a, 13b and to use the type of conductor connection provided. Therefore, a slot-like cavity can also indicate, for example, the negative polarity or an earth potential of the voltage potential provided for the conductor connection, whereas the slot indicates a positive voltage potential or a voltage-conducting phase. Virtually any further designs of the cavity 3a, 3b are feasible.

In the left-hand illustration of the head section 12 of the operating pusher 8a, it is clear that the operating pusher 8a is pivoted to the left into the recess covered by the insulating-material housing 6 (compared to the adjoining right-hand illustration of the plan view of the operating pusher 8a).

FIG. 3 shows a cross-sectional view of a second embodiment of the conductor terminal 1, in which a recess 11a, 11b is made in the side wall of the guide channels 10a, 10b.

As can be seen in the sectional view from FIG. 4 through the guide channel 10, the operating pusher 8 can be pivoted laterally into the recess 11 with the aid of a flexible section 14. The head section 12 then butts against the upper edge of the recess 11 and is wedged in there in order to prevent the operating pusher 8 from bouncing up and thereby closing the spring-force clamping contact 4 (not illustrated in FIG. 4) which is operatively connected to the operating pusher 8.

FIG. 5 shows a detailed sectional view of a third embodiment of the conductor terminal 1. It is clear that the operating pusher 8 is of two-part design and has a main operating element 15 and an arresting operating element 16 which is illustrated in the open and in the closed position.

The main operating element 15 has, at least on the wall which adjoins the arresting operating element 16, indentations 17 in the form of incisions which run obliquely into the material of the main operating element 15 in the direction of the spring-force clamping contact 4. A recess 11 is again made in the guide channel 10 for the main operating element 15, and so a clearance is created between the indentation 17 and the recess 11. This clearance is used by an arresting plate 18 of the arresting operating element 16, which arresting plate branches obliquely from a lug 19 of the arresting operating element 16. When the main operating element 15 is pressed down in order to open the associated spring-force clamping contact 4, the indentation 17 is located obliquely beneath the upper edge of the recess 11, and so the arresting plate 18 can be clamped between the upper edge of the recess 11 and the lower edge of the indentation 17 when the lug 19 is drawn in the upward direction out of the insulating-material housing 6. It is therefore possible to arrest the operating pusher 8 without the aid of the tool. In addition, the open state of the spring-force clamping contact 4 can be made clearly visible from the outside.

1. Conductor terminal (1) having an insulating-material housing (6), at least one spring-force clamping contact (4) which is accommodated in the insulating-material housing (6), and having at least one operating pusher (8) which is operatively connected to a respective spring-force clamping contact (4) and is displaceably guided in a guide channel (10) in the insulating-material housing (6) in order to open and to close the associated spring-force clamping contact (4), characterized in that the at least one guide channel (10) has an recess (11) for accommodating a section of the operating pusher (8) which is guided in the respective guide channel (10), and in that the recess (11) and the section of the operating pusher (8) are matched to one another in such a way that the operating pusher can be fixed in an unlocking position, in which the spring-force clamping contact (4) is open, in the recess (11).

2. Conductor terminal (1) according to claim 1, characterized in that the operating pusher (8) has several parts and has at least two operating elements (8) which are mounted such that they can be displaced relative to one another, of which a main operating element (15) is operatively connected to an associated spring-force clamping contact (4) and an arresting operating element (16) is provided on that section which interacts with the recess (11) in the guide channel (10) and the main operating element (15), in order to fix the main operating pusher (15).

3. Conductor terminal (1) according to claim 2, characterized in that the arresting operating element (16) has a lug (19) which extends in the longitudinal direction of the guide channel (10) and projects from the insulating-material housing (6) and has an arresting plate (18) which branches obliquely from the lug (19), and at least one indentation (17) is provided in that wall of the main operating element (15) which adjoins the lug (19), said indentation being matched to the recess (11) in the guide channel (10) and the arresting plate (18) for fixing the main operating element (15) in an unlocking position, in which the spring-force clamping contact (4) is open, and/or in a locking position, in which the spring-force clamping contact (4) is closed.

4. Conductor terminal (1) according to claim 3, characterized in that the at least one indentation (17) in the main operating element (15) enters the material of the main operating element (15) obliquely in the direction of the spring-force clamping contact (4).

5. Conductor terminal (1) according to claim 1, characterized in that at least one guide channel (10) and/or operating pusher (8) has conically tapering wall sections in such a way that that the operating pusher (6) is mounted in the guide channel (10) such that it can pivot into the recess (11) in the guide channel (10).

6. Conductor terminal (1) according to claim 1, characterized in that at least one operating pusher (8) has a flexible section (14) in such a way that the section (14) of the operating pusher (8) can be pivoted into the recess (11) in the guide channel (10).

7. Conductor terminal (1) according to claim 1, characterized by a cavity (13) in the externally accessible head section (12) of the operating pusher (8), which cavity is intended to receive an operating tool.

8. Conductor terminal (1) according to claim 7, characterized in that the shape of the cavity (13) represents an identifier of a predefined type of conductor connection of the associated conductor connection.

9. Conductor terminal (1) according to claim 8, characterized in that the type of conductor connection is the polarity or phase of the voltage potential provided for the conductor connection.

10. Conductor terminal (1) according to claim 1, characterized in that. a warning cover cap for closing the guide channel (10) is connected in a pivotable and articulated manner to the outer wall of the insulating-material housing (6) so as to adjoin the guide channel (10).
